(19) United States
(12) Patent Application Publication
(10) Pub. No.: US 2010/0308513 A1
(43) Pub. Date: Dec. 9, 2010

(54) TEMPLATE AND PATTERN FORMING METHOD

(76) Inventors: Hiroyuki Kashiwagi, Fujisawa-shi (JP); Kazuya Fukuhara, Tokyo (JP); Ryoichi Inanami, Yokohama-shi (JP); Takuya Kono, Yokosuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/796,343

(22) Filed: Jun. 8, 2010

(30) Foreign Application Priority Data
Jun. 9, 2009 (JP) 2009-138497

(51) Int. Cl. B29C 35/08

(52) U.S. Cl. 264/496; 425/470

(57) ABSTRACT

According to one embodiment, a template for imprint lithography includes a transparent substrate having a pattern with a recess portion and a protruding portion, and a light-shielding portion formed on a bottom surface of the recess portion and on a top surface of the protruding portion. A side wall of the protruding portion is inclined.

### CROSS-REFERENCE TO RELATED APPLICATIONS

This application is based upon and claims the benefit of priority from Japanese Patent Application No. 2009-138497, filed Jun. 9, 2009; the entire contents of which are incorporated herein by reference.

### FIELD

Embodiments described herein relate generally to a template and a pattern forming method.

### BACKGROUND

A nanoimprint method has been proposed which serves as a technique for transferring fine patterns during a process of manufacturing semiconductor devices. In the nanoimprint method, a template (mold) with element patterns is contacted with a photo-curable material layer to transfer the element patterns to the photo-curable material layer.

In connection with the nanoimprint method, a method using near-field light has been proposed which method allows finer patterns to be formed (for example, see Jpn. Pat. Appln. KOKAI Publication No. 2006-287012). In the method using near-field light, a light-shielding portion is formed on each imprint pattern of the template. Specifically, a metal film is formed on the bottom surface of each imprint pattern recess portion and on the top surface of each imprint pattern protruding portion. Then, as is the case with the normal nanoimprint method, the template is contacted with a photo-curable layer (a resist layer or the like) to fill the photo-curable material into the recess portions of the template. In this state, the template is irradiated with light. Then, near-field light is generated near the edge of each of the patterns (near the boundary between each recess portion and the corresponding protruding portion) to cure the photo-curable material. That is, the photo-curable material layer can be selectively cured near the edge of each pattern. Thus, for example, line and space patterns can be formed at a pitch that is half that of the patterns formed on the template.

However, optimization of the template has not been sufficiently considered for the nanoimprint method using near-field light as described above. Thus, accurate and reliable formation of fine patterns is difficult.

### BRIEF DESCRIPTION OF THE DRAWINGS

FIG. 1 is a sectional view schematically showing the configuration of a template according to an embodiment;

FIG. 2 is a plan view schematically showing the configuration of the template according to the embodiment;

FIG. 3 is a sectional view schematically showing a part of a pattern forming method according to the embodiment;

FIG. 4 is a sectional view schematically showing a part of the pattern forming method according to the embodiment;

FIG. 5 is a plan view schematically showing a part of the pattern forming method according to the embodiment;

FIG. 6 is a plan view schematically showing a part of the pattern forming method according to the embodiment;

FIG. 7 is a sectional view schematically showing a part of the pattern forming method according to the embodiment;

FIG. 8 is a diagram showing simulation results for the intensity distribution of near-field light;

FIG. 9 is a diagram showing simulation results for the intensity distribution of near-field light;

FIG. 10 is a diagram showing simulation results for the relationship between an inclination angle and the near-field light intensity;

FIG. 11 is a diagram showing simulation results for the relationship between the film thickness of a light-shielding portion and the contrast of the near-field light intensity;

FIG. 12 is a diagram showing simulation results for the relationship between the film thickness of the light-shielding portion and the contrast of the near-field light intensity;

FIG. 13 is a sectional view schematically showing a part of a method for manufacturing a template according to the embodiment;

FIG. 14 is a sectional view schematically showing a part of the method for manufacturing the template according to the embodiment;

FIG. 15 is a sectional view schematically showing a part of the method for manufacturing the template according to the embodiment;

FIG. 16 is a sectional view schematically showing a part of the method for manufacturing the template according to the embodiment;

FIG. 17 is a plan view schematically showing a part of a pattern forming method according to the embodiment;

FIG. 18 is a plan view schematically showing a part of the pattern forming method according to the embodiment;

FIG. 19 is a sectional view schematically showing a part of the pattern forming method according to the embodiment;

FIG. 20 is a sectional view schematically showing a part of the pattern forming method according to the embodiment;

FIG. 21 is a sectional view schematically showing a part of the pattern forming method according to the embodiment; and

FIG. 22 is a sectional view schematically showing a part of the pattern forming method according to the embodiment.

### DETAILED DESCRIPTION

In general, according to one embodiment, a template for imprint lithography includes a transparent substrate having a pattern with a recess portion and a protruding portion, and a light-shielding portion formed on a bottom surface of the recess portion and on a top surface of the protruding portion. A side wall of the protruding portion is inclined.

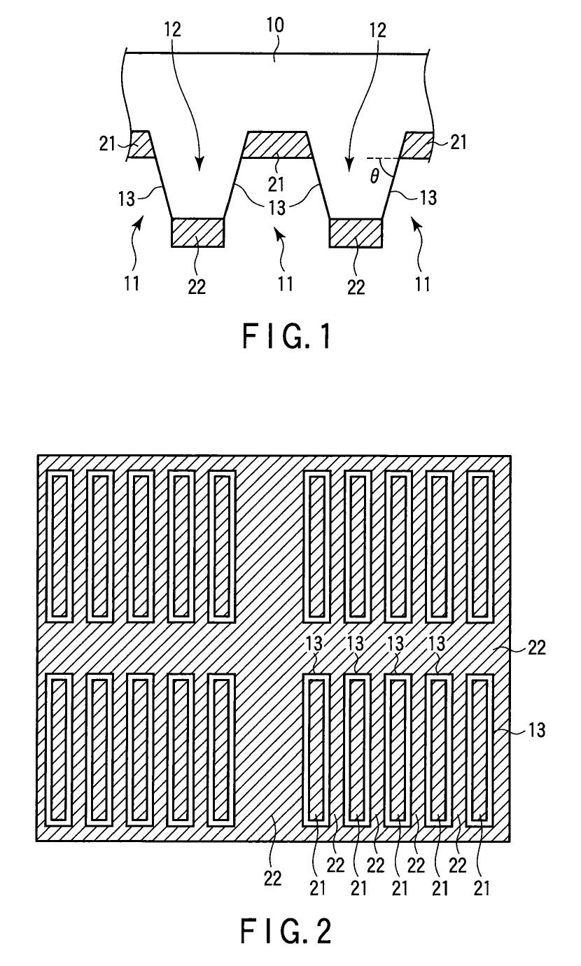

First, the configuration of a template for nanoimprint lithography according to the present embodiment will be described with reference to FIG. 1 and FIG. 2. FIG. 1 is a sectional view schematically showing the configuration of the template. FIG. 2 is a plan view schematically showing the configuration of the template. In the description below, fine line and space patterns are formed.

The main body of the template is formed of a transparent substrate 10 such as quartz glass. The transparent substrate 10 includes recess portions 11 and protruding portions 12 which allow imprint patterns to be formed. A side wall 13 of each of the protruding portions 12 is inclined (the side wall 13 also forms a side wall of the corresponding recess portion 11). That is, an inclination angle θ shown in FIG. 1 is smaller than 90 degrees. The template recess portion is configured so as to broaden from the bottom to the top surface of the corresponding protruding portion. In contrast, the template protruding portion is configured so as to be thinner from the bottom to the top surface.

A light-shielding portion 21 is formed on the bottom surface of the recess portion 11. A light-shielding portion 22 is formed on the top surface of the protruding portion 12. The light-shielding portions 21 and 22 are formed of a metal film of thickness about 10 nm to 50 nm. Chromium (Cr), silver (Ag), or the like can be used as the metal film. In the example shown in FIG. 2, the light-shielding portion 21 is positioned inside the side wall 13, and the light-shielding portion 22 is positioned outside the side wall 13. However, the light-shielding portion 22 may be positioned inside the side wall 13, and the light-shielding portion 21 may be positioned outside the side wall 13.

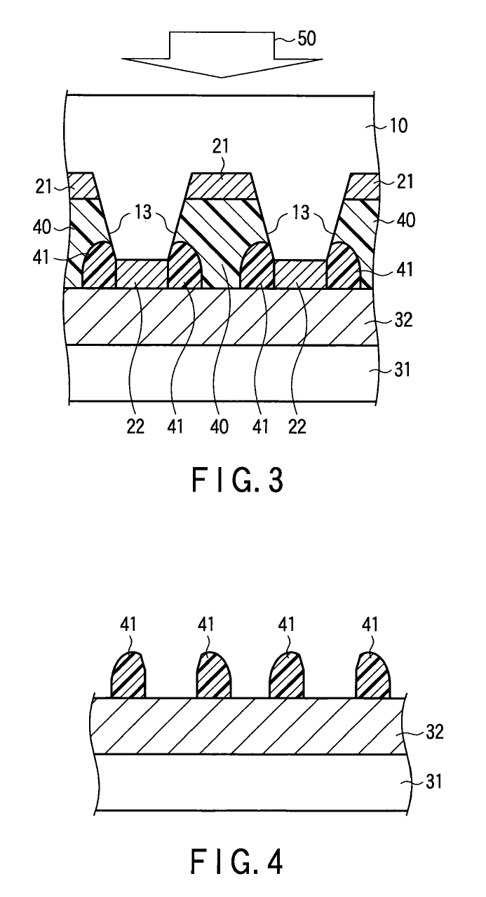

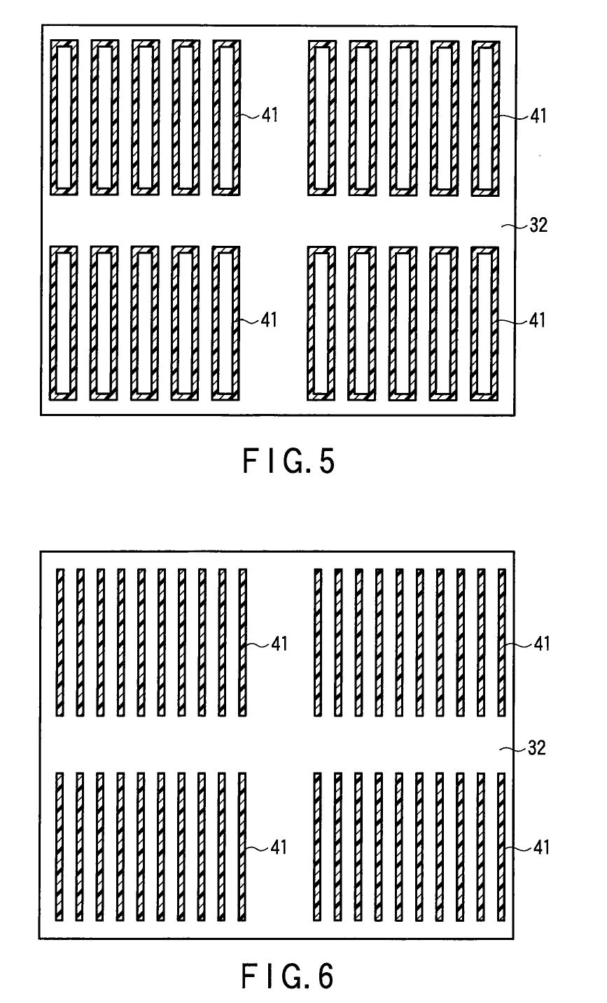

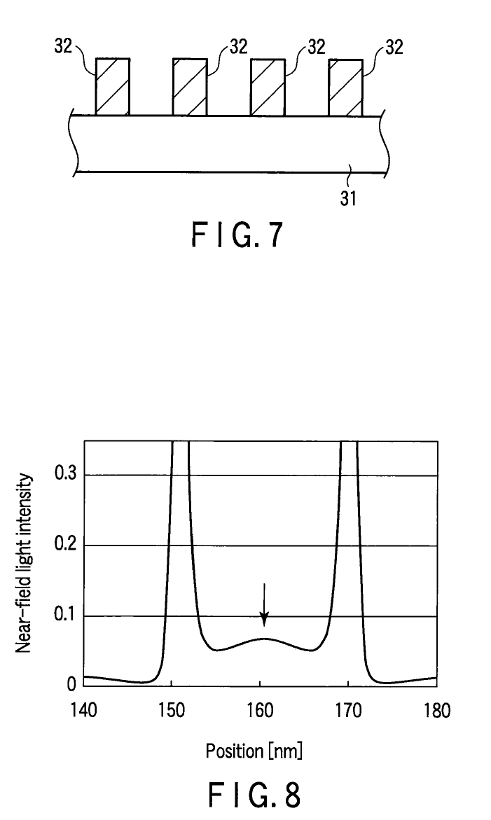

Now, a pattern forming method using the above-described template will be described with reference to FIG. 3 to FIG. 7. FIG. 3, FIG. 4, and FIG. 7 are sectional views. FIG. 5 and FIG. 6 are plan views.

In the step shown in FIG. 3, first, a processing target film 32 is formed on an underlying region 31 including a semiconductor substrate. An example of the processing target film 32 is a metal film, an insulating film, or a semiconductor film. Then, a photo-curable material 40 is coated on the processing target film 32 to form a photo-curable material layer. A resist material for nanoimprint lithography can be used as the photo-curable material. Subsequently, the template shown in FIG. 1 and FIG. 2 is contacted with the photo-curable material layer to fill the photo-curable material 40 into the recess portions of the template. In this state, the template is irradiated with light 50 from above the template. Then, near-field light is generated near the edge of each of the light-shielding portions 21 and 22 (near the boundary between each of the recess portions and the corresponding protruding portion) to cure a part of the photo-curable material 40 which is filled in the recess portion. That is, parts of the photo-curable material 40 positioned near the respective side walls 13 are cured. As a result, a photo-curable material pattern 41 is formed near each of the side walls 13.

Then, as shown in FIG. 4, the template is separated from the photo-curable material layer, with the photo-curable material patterns 41 left on the processing target film 32. Uncured parts of the photo-curable material normally remain on the processing target film 32. Thus, after the template is separated from the photo-curable material layer, the uncured parts of the photo-curable material remaining on the processing target film 32 are removed. Specifically, the uncured parts of the photo-curable material are removed by etching with a mixed liquid of sulfuric acid and hydrogen peroxide and further by plasma etching with oxygen gas.

FIG. 5 is a plan view schematically showing the shape of the photo-curable material patterns 41 resulting from the step shown in FIG. 4. As already described, each of the photo-curable material patterns 41 is formed at a position corresponding to the side wall of the corresponding one of the protruding portions of the template. Thus, as shown in FIG. 5, the photo-curable material pattern 41 is shaped like a closed loop. Hence, to allow line and space patterns to be formed, the opposite ends of each closed loop-like pattern need to be removed. Thus, as shown in FIG. 6, the opposite ends of the closed loop-like photo-curable material pattern 41 are removed. This step will be described below in detail.

Then, the processing target film 32 is processed by etching using, as a mask, the photo-curable material patterns 41 obtained in the step shown in FIG. 6. Moreover, the photo-curable material patterns 41 used as a mask are removed. As a result, as shown in FIG. 7, patterns (line and space patterns) of the processing target film 32 are formed on the underlying region 31. That is, fine line and space patterns can be formed at a pitch smaller than that of the patterns formed on the template, for example, half the pitch.

In the present embodiment, as shown in FIG. 1, the side wall 13 of each of the protruding portions 12 of the template is inclined. The thus inclined side wall 13 allows fine patterns to be accurately and reliably formed as described below.

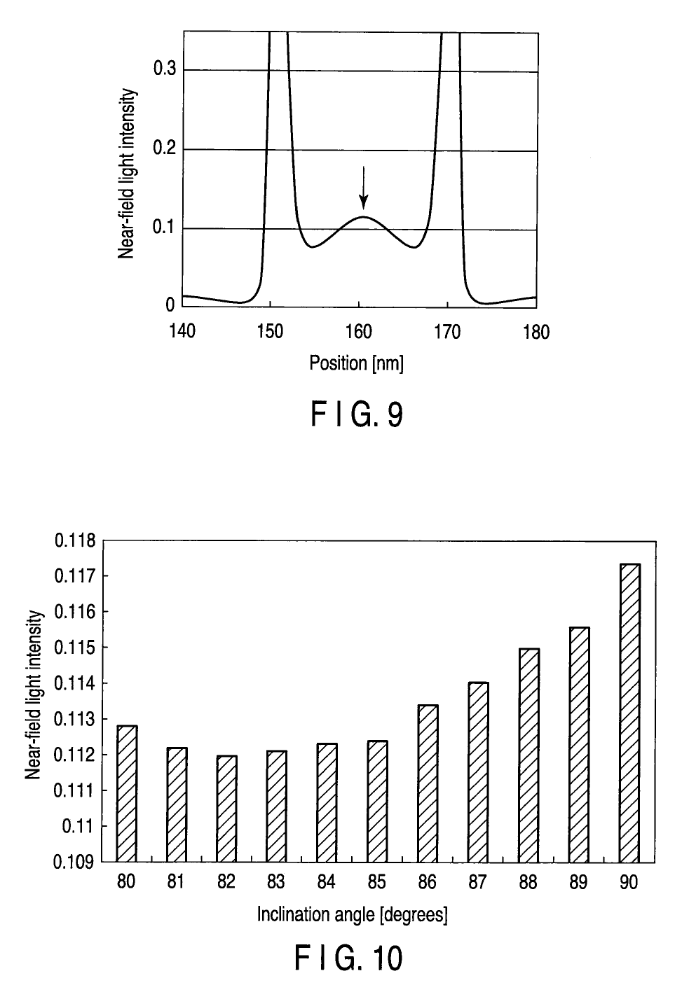

FIG. 8 and FIG. 9 are diagrams showing simulation results for the intensity distribution of near-field light. FIG. 8 shows the simulation results for the case in which the inclination angle θ of the side wall 13 shown in FIG. 1 is 85 degrees. FIG. 9 shows the simulation results for the case in which the side wall 13 is not inclined (the inclination angle θ is 90 degrees). In both cases, the width of each of the recess portion 11 and the protruding portion 12 is 20 nm. The height of the protruding portion 12 is 40 nm. The thickness of each of the light-shielding portions (Cr films) 21 and 22 is 30 nm.

In FIG. 8 and FIG. 9, two positions with very high near-field light intensities correspond to the positions of the side walls 13. In FIG. 9 (θ=90 degrees), a relatively high intensity peak is observed in a central part (which is shown by an arrow). When such an intensity peak is generated between the side walls 13, the photo-curable material may be cured even in the central part between the side walls 13. This may preclude the desired photo-curable material patterns from being obtained. In contrast, in FIG. 8 (θ is 85 degrees), the peak in the central part is significantly lower. This prevents the photo-curable material from being cured in the central part between the side walls 13. Thus, the desired photo-curable material patterns can be reliably obtained.

FIG. 10 is a diagram showing simulation results for the relationship between the inclination angle θ and the near-field light intensity. The near-field light intensity corresponds to the intensity at the central part (which is shown by the arrow) in FIG. 8 and FIG. 9. As shown in FIG. 10, the near-field light intensity decreases as the inclination angle θ decreases from 90 degrees to about 85 degrees. Thus, the simulation results also indicate that the inclined side walls 13 allow the near-field light intensity to be reduced at the central part between the side walls 13.

As described above, in the present embodiment, the side wall of each of the protruding portions of the template is inclined. This allows the near-field light intensity to be reduced in the areas other than those required to form the desired patterns. As a result, fine patterns can be accurately and reliably formed. Thus, a semiconductor device (semiconductor integrated circuit device) with fine patterns can be accurately and reliably manufactured by applying the method according to the present embodiment to the manufacture of the semiconductor device.

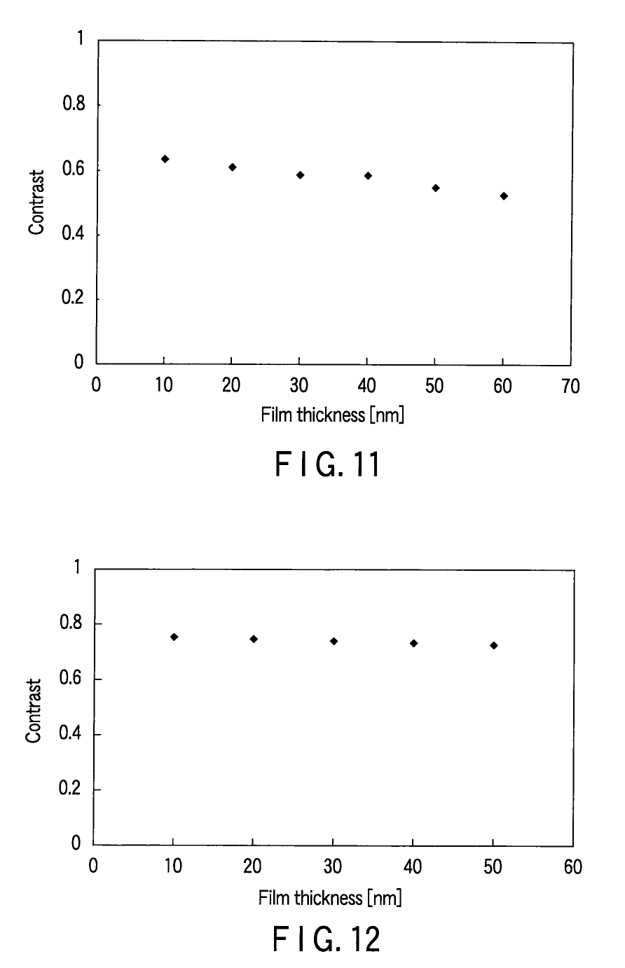

FIG. 11 is a diagram showing simulation results for the relationship between the film thickness of the light-shielding portion (Cr film) 21 shown in FIG. 1 and the contrast of the near-field light intensity. FIG. 12 is a diagram showing simulation results for the relationship between the film thickness of the light-shielding portion (Cr film) 22 shown in FIG. 1 and the contrast of the near-field light intensity. The contrast of the near-field light intensity is defined as follows. The near-field light intensity at the position of the side wall 13 is defined as Imax. The near-field light intensity at the central part between the side walls 13 is defined as Imin. The contrast C of the near-field light intensity is defined by:

C=(Imax−Imin)/(Imax+Imin)

As shown in FIG. 11 and FIG. 12, when the film thickness of the light-shielding portion 21 is between about 10 nm and about 50 nm, the contrast of the near-field light intensity does not substantially depend on the film thickness. Thus, the effects of the above-described embodiment can be exerted without dependence on the film thickness of the light-shielding portion 21.

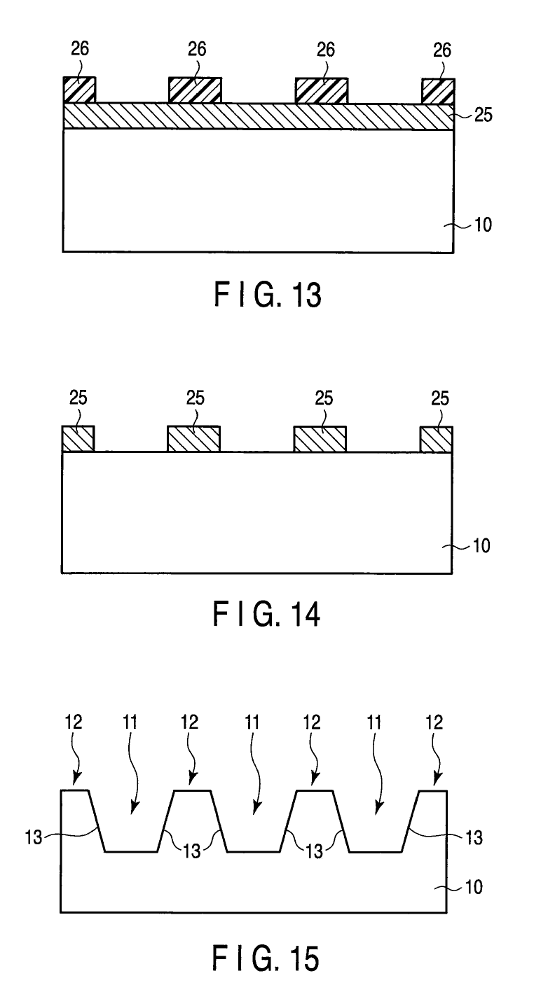

Now, a method for manufacturing such a template as described above will be described. FIG. 13 to FIG. 16 are sectional views schematically showing the method for manufacturing the template.

First, as shown in FIG. 13, as an etching mask film 25, a chromium (Cr) film is formed on a transparent substrate 10 such as quartz glass. Subsequently, an EB (electron beam) resist film is formed on the mask film 25. Then, the EB resist film is patterned by EB writing to form EB resist patterns 26.

Then, as shown in FIG. 14, the mask film 25 is etched through the EB resist patterns 26 as a mask. Thus, mask patterns 25 are formed on the transparent substrate 10.

Then, as shown in FIG. 15, the transparent substrate 10 is etched by BHF (buffered hydrofluoric acid) through the mask patterns 25 as a mask. Thus, recess portions 11 and protruding portions 12 are formed at the transparent substrate 10. Furthermore, the side wall 13 of the each of the protruding portions 12 is taperedly inclined. Moreover, the mask patterns 25 are removed.

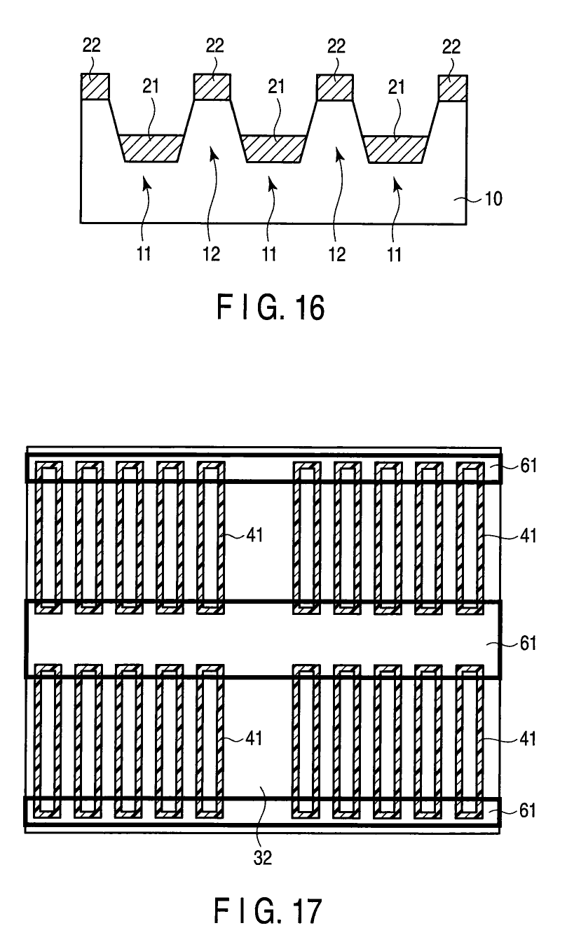

Then, as shown in FIG. 16, a metal film is deposited on the transparent substrate 10 by a vapor deposition method. A chromium (Cr) film, a silver (Ag) film, or the like can be used as the metal film. Thus, a light-shielding portion 21 is formed on the bottom surface of each of the recess portions 11. A light-shielding portion 22 is formed on the top surface of each of the protruding portions 12. The metal film may be formed on the side wall 13. However, the metal film formed on the side wall 13 is very thin and thus does not form a light-shielding portion. A material for the metal film is generally Cr, Ag, Au, Pt, Cu, Al, Ti, or an alloy containing any of these elements.

As described above, a template is obtained in which the light-shielding portions 21 and 22 are selectively formed on the recess portions 11 and protruding portions 12 of the transparent substrate 10.

Now, the process shown in FIGS. 5 and 6 for the above-described embodiment will be described. That is, the process of removing the opposite ends of the closed loop-like pattern will be described.

First, a first example will be described with reference to a plan view in FIG. 17. In the first example, after the step shown in FIG. 5, as shown in FIG. 17, an irradiation region 61 is irradiated with EBs (Electron Beams) or FIBs (Focused Ion Beams) to remove the opposite ends of each of the closed loop-like photo-curable material patterns 41. Thus, such patterns as shown in FIG. 6 are obtained.

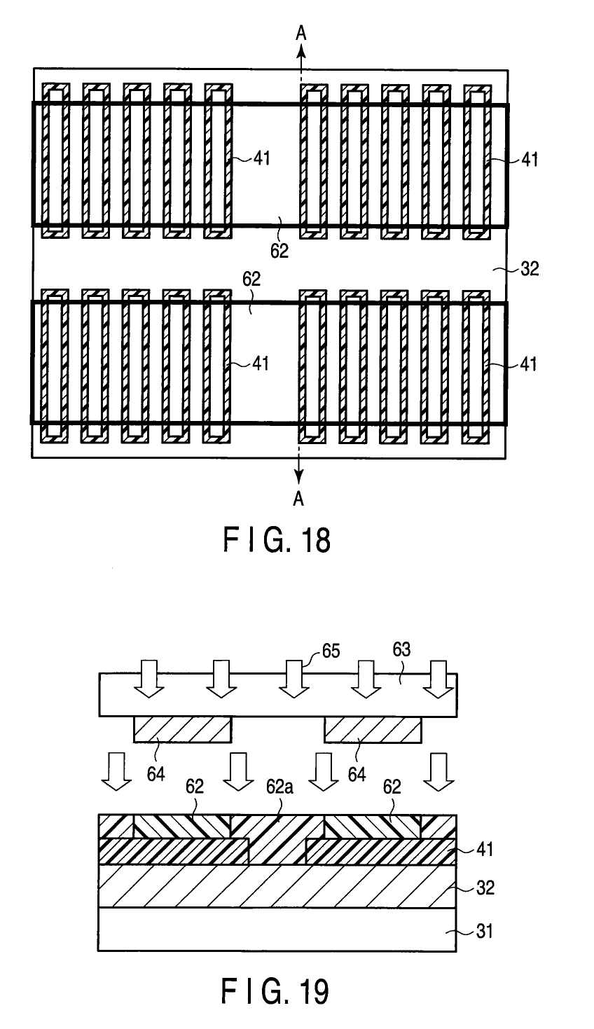

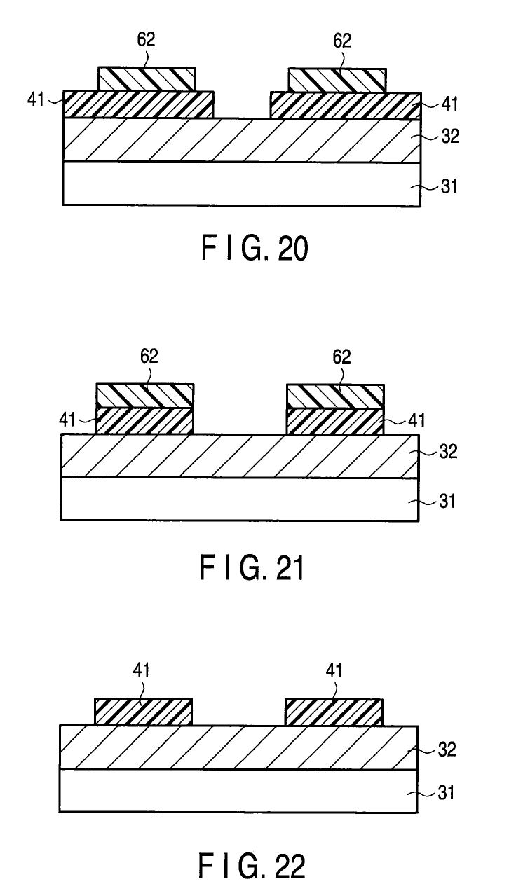

Now, a second example will be described with reference to a plan view in FIG. 18 and sectional views in FIG. 19 to FIG. 22. A cross section taken along line A-A in FIG. 18 corresponds to FIG. 20.

In the second example, after the step shown in FIG. 5, as shown in FIG. 19, a photo resist film 62 is formed on the processing target film 32 and on the photo-curable material patterns 41. Subsequently, the photo resist film 62 is irradiated with exposure light 65 via a photo mask 63 with light-shielding patterns 64. Thus, exposed portions 62a are formed in the photo resist film 62. The exposed portions 62a overlap the ends (which are to be removed) of each of the photo-curable material patterns 41.

Then, as shown in FIG. 20, the photo resist film 62 is developed to remove the exposed portions 62a. Thus, photo resist patterns 62 are formed. As shown in FIG. 18, the photo resist patterns 62 cover the regions other than the opposite ends of each of the photo-curable material patterns 41.

Then, as shown in FIG. 21, the photo-curable material patterns 41 are etched through the photo resist patterns 62 as a mask. In this case, plasma etching with, for example, oxygen gas is used. Thus, the opposite ends of each of the photo-curable material patterns 41 are removed.

Then, as shown in FIG. 22, the photo resist patters 62 are removed. Thus, such patterns as shown in FIG. 6 are obtained.

The opposite ends of each of the photo-curable material patterns 41 are removed as described above. Thus, each closed loop-like pattern can be separated into two parts. Therefore, the desired photo-curable material patterns can be reliably obtained.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A template for imprint lithography comprising:
a transparent substrate having a pattern with a recess portion and a protruding portion; and
a light-shielding portion formed on a bottom surface of the recess portion and on a top surface of the protruding portion,
wherein a side wall of the protruding portion is inclined.

2. The template according to claim 1, wherein the light-shielding portion is formed of a metal film.

3. The template according to claim 2, wherein the metal film contains at least one of Cr, Ag, Au, Pt, Cu, Al, and Ti.

4. The template according to claim 1, wherein the light-shielding portion has a thickness of between 10 nm and 50 nm.

5. The template according to claim 1, wherein the recess portion of the template broadens from the bottom surface of the recess portion toward the top surface of the protruding portion.

6. The template according to claim 1, wherein the template is used to form a line and space pattern.

7. A pattern forming method comprising:
contacting the template according to claim 1 with a photo-curable material on a processing target film to fill the photo-curable material into the recess portion;
irradiating the template with light to cure that part of the photo-curable material which positioned near the side wall to form a photo-curable material pattern; and
separating the template after the photo-curable material pattern has been formed.

8. The method according to claim 7, wherein the photo-curable material pattern is a closed loop-like pattern.

9. The method according to claim 8, further comprising removing a part of the photo-curable material pattern to cut the closed loop-like pattern after the template has been separated.

10. The method according to claim 9, wherein when the closed loop-like pattern is cut, opposite ends of the closed loop-like pattern are cut.

11. The method according to claim 7, wherein the template is irradiated with light to generate near-field light.

12. The method according to claim 11, wherein the near-field light is generated near an edge of the light-shielding portion.
